(19) United States
(12) Patent Application Publication
(10) Pub. No.: US 2026/0202706 A1
(43) Pub. Date: Jul. 16, 2026

(54) REFLECTIVE COLOR DISPLAY WITH COLOR FILTER LAYER

(71) Applicant: SUPERC-TOUCH CORPORATION, New Taipei City (TW)

(72) Inventors: Hsiang-Yu LEE, New Taipei City (TW); Shang CHIN, New Taipei City (TW); Ping-Tsun LIN, New Taipei City (TW); Chia-Cheng LEI, New Taipei City (TW); Kun-Yu CHEN, New Taipei City (TW)

(73) Assignee: SUPERC-TOUCH CORPORATION, New Taipei City (TW)

(21) Appl. No.: 19/442,115

(22) Filed: Jan. 7, 2026

(30) Foreign Application Priority Data
Jan. 10, 2025 (TW) 114101147

(51) Int. Cl. G02F 1/1362; G02F 1/1343; G02F 1/1368

(52) U.S. Cl. CPC G02F 1/136222; G02F 1/134309; G02F 1/1368; G02F 2203/02

(57) ABSTRACT

A reflective color display with color filter layer includes a first substrate, a thin film transistor layer, a pixel electrode layer, a color filter layer, and a display material layer. The pixel electrode layer includes a plurality of pixel electrodes and the color filter layer includes a plurality of color filter blocks. Part of the color filter blocks are in one-by-one correspondence with the pixel electrodes, part of the color filter blocks are in multiple-to-one or one-to-multiple correspondence with the pixel electrodes.

### CROSS-REFERENCE TO RELATED APPLICATIONS

This application claims priority to and the benefit of Taiwan Patent Application No. 114101147, filed on Jan. 10, 2025, disclosures of which are incorporated herein by reference in its entirety.

### BACKGROUND OF THE DISCLOSURE

### Technical Field

This invention relates to a reflective color display, and more particularly to a reflective color display with a color filter layer.

### Description of Related Art

The ideal electronic paper needs to have advantages of lightweight, low energy consumption, and flexibility. In addition, electronic paper can retain images even after power off Therefore, electronic paper has been widely used in applications such as books, labels, posters, bulletin boards, etc. In the past, various electronic paper technologies have been proposed, such as electronic powder fluid (quick response liquid powder display), cholesteric liquid crystal display and other displays. However, electrophoresis displays (EPDs) are still the mainstream in view of practical considerations such as image display quality, electronic drive system design complexity and mass production stability. In addition, with more desirable application, color electronic paper has gradually become a development focus. Color electronic paper is bistable color display and does not require power to maintain the displayed image except the situation of updating display content. In comparison with liquid crystal displays (LCDs) constantly needing power, color electronic paper significantly reduces power consumption. The other advantages of the color electronic paper include environmentally friendly, energy-saving, eye-friendly, and viewable in sunlight. The electronic paper and reflective LCDs display images by reflecting ambient light, which are different with conventional backlit LCDs which emit blue light. Therefore, the user feels more comfortable for the eyes thereof and less tiring when viewing electronic paper displays or reflective LCDs.

The existing color electronic paper can mimic the LCD display manner, namely, use color photoresists (such as three primary color RGB photoresists) on the color filters to filter out part of the spectrum in white light to convert the white light into colored light. This technology only requires two-color electronic ink films (black and white) in conjunction with color filter blocks. However, this technology suffers the biggest weakness below. Two-thirds of the incident white light is absorbed by the color filter blocks, and only about one-third of the incident light can be reflected, resulting in darker image. The traditional LCDs solve this problem by using high-brightness backlights to compensate the reduced brightness caused by the color filter mechanism to maintain the image at normal brightness. However, this also causes excessive power consumption. The color electronic paper not equipped with backlighting cannot overcome this issue, and the relevant industry has spent over a decade to developpe solution in vain. Currently, the color electronic paper using color filter mechanism relies on front light to supplement brightness. However, due to structural limitations and reflection principles, the effectiveness of the front light is far inferior to that of LCD backlighting. Furthermore, the addition of a front light significantly influences the eye-friendly features of the color electronic paper.

As shown in FIG. 9, the prior art color electrophoresis display 100 includes, from top to bottom, an upper glass substrate 16, a color filter layer CF, an optical adhesive 13, an opposite substrate 12 (for example, a transparent plastic substrate), a common electrode layer 14 (for example, a transparent conductive electrode layer), a display material layer 20 (for example, an electrophoresis layer), a pixel electrode layer PEL, a thin-film transistor layer 30, and a control substrate 10 (for example, a glass substrate). As shown in FIG. 9, the display material layer 20 includes a plurality of hollow micro-cups 22 (only one is shown in the figure), and a colloidal solution 24 filled in each of the micro-cups 22. The colloidal solution 24 contains a plurality of suspended charged color particles 26 (for example, charged black particles 26B and charged white particles 26W). The hollow micro-cups 22 serves as containers for electronic ink (or electrophoresis material). The hollow micro-cups 22 are, for example, made of organic polymer materials and are used to fill the charged color particles 26.

The common electrode layer 14 is generally connected to ground level (OV) to provide a common voltage Vcom, and the underlying control substrate 10 generally uses the TFT array process of a panel to fabricate a driving circuit layer and a thin-film transistor layer 30. The charged color particles 26 carry charges of predetermined polarities. For example, the charged black particles 26B are positively charged and the charged white particles 26W are negatively charged. By controlling the electrical properties and voltage for each of the pixel electrodes PE through driving the thin-film transistor layer 30 by the driving circuit layer (not shown), the charged black particles 26B are attracted and the charged white particles 26W are repelled for each pixel (such that the pixel appears white on the viewing surface opposite to the pixel electrode PE) or the charged white particles 26W are attracted to location near the color filter block and the charged black particles 26B are repelled for each pixel, thereby displaying a predetermined image on the display surface, such as the surface close to the upper glass substrate 16.

The electrophoresis displays with color filter arrays rely on area sharing and color mixing to produce viewable colors. Available display areas are shared among the three primary colors, such as red/green/blue (RGB) or red/green/blue/white (RGBW), or the three primary colors plus white. The color filter layers can be arranged in a one-dimensional (stripes) or two-dimensional (2×2) repeating patterns. If the three pixels (in the RGB display case) or the four pixels (in the RGBW display case) are small enough, those pixels can be seen as a single pixel unit (display unit) with uniform color with high resolution and visually blending color.

FIG. 1A shows an embodiment of a prior art color filter layer CF. With reference to this figure, this color filter layer CF is, for example, a red/green/blue (RGB) color filter layer for three primary colors. Each of the color filter layers includes color filter blocks in substantially rectangular shape for three primary colors, and the color filter block for one primary color (for example, red filter block R) is surrounded by color filter blocks of other colors (for example, blue filter block B or green filter block G). FIG. 1B shows the color mixing methods for displaying red, green, and blue colors respectively according to the color filter layer CF in FIG. 1A. With reference also to FIG. 9, if a display unit is planned to display red color, the pixel electrode PE1 corresponding to the red filter block R is applied with a driving voltage under the control of the thin-film transistor layer 30 to attract charged white particles 26W to location near the color filter block to reflect light. Therefore, the area corresponding to the red filter block R display red color. Similarly, the pixel electrodes PE2 and PE3 corresponding to the green filter block G and the blue filter block B can be applied with a driving voltage under the control of the thin-film transistor layer 30 to attract charged black particles 26B to location near the color filter block to not reflect light. Therefore, the areas corresponding to the green filter block G and the blue filter block B are black (K) color, thereby making the pixel display red color. Under this condition, the color and brightness of this display unit (containing three pixels) are R+Black+Black=R.

Similarly, if a display unit is planned to display green color, the pixel electrode PE2 corresponding to the green filter block G is applied with a driving voltage through the thin-film transistor layer 30 controlled by the driving circuit layer to attract charged white particles 26W to location near the color filter block to reflect light. Therefore, the area corresponding to the green filter block G displays green color. Similarly, the pixel electrodes PE1 and PE3 corresponding to the red filter block R and the blue filter block B can be applied with a driving voltage through the thin-film transistor layer 30 to attract charged black particles 26B to location near the color filter block to not reflect light. Therefore, the areas corresponding to the red filter block R and the blue filter block B are black (K), thereby making the pixel display green color. Under this condition, the color and brightness of this display unit (containing three pixels) are G+Black+Black=G.

If a display unit is planned to display blue color, the corresponding pixel electrodes PE1 to PE3 can be controlled in a similar manner. In this case, the color and brightness of this display unit (containing three pixels) are B+Black+Black=B. However, in this control method, only ⅓ of each pixel display color, while ⅔ are black, so the overall brightness is relatively dim.

With reference to FIG. 1C, this figure is a schematic diagram to show the color mixing methods for displaying yellow (Y), magenta (M), and cyan (C) based on the color filter layer CF in FIG. 1A. If a display unit is planned to display yellow color, the pixel electrode PE1 corresponding to the red filter block R and the pixel electrode PE2 corresponding to the green filter block G are applied with driving voltages under the control of the thin-film transistor layer 30 to attract charged white particles 26W to location near the color filter block to reflect light. The pixel electrode PE3 corresponding to the blue filter block B is applied with a driving voltage under the control of the thin-film transistor layer 30 to attract charged black particles 26B to location near the color filter block to not reflect light, making the area corresponding to the blue filter block B is black (K). The areas corresponding to the red filter block R and the green filter block G can display red color and green color respectively, and the color additive effect is yellow. In this case, the color and brightness of this display unit (containing three pixels) are R+G+Black=Y.

Similarly, if a display unit is planned to display magenta color, the pixel electrode PE1 corresponding to the red filter block R and the pixel electrode PE3 corresponding to the blue filter block B are applied with driving voltages under the control of the thin film transistor layer 30 to attract charged white particles 26W to location near the color filter block to reflect light. The pixel electrode PE2 corresponding to the green filter block G is applied with a driving voltage under the control of the thin film transistor layer 30 to attract charged black particles 26B to location near the color filter block to not reflect light. The area corresponding to the green filter block G is black (K), while the areas corresponding to the red filter block R and the blue filter block B display red color and blue color respectively, and the colors are additive to form magenta color. In this case, the color and brightness of this display unit (containing three pixels) are B+R+Black=M.

If a display unit is planned to display cyan color, the corresponding pixel electrodes PE1 to PE3 can be controlled in a similar manner. In this situation, the color and brightness of this display unit (containing three pixels) are B+G+Black=C. However, according to the above control method, only ⅔ of these pixels have color, while ⅓ portion of these pixels is black; this will result in brightness differences between displaying red, blue, and green, and displaying yellow, magenta, and cyan.

With reference to FIG. 1D, this figure is a schematic diagram to show the color mixing methods for displaying white (W) and black (K) based on the color filter layer CF in FIG. 1A. If a display unit is planned to display white, the pixel electrode PE1 corresponding to the red filter block R, the pixel electrode PE2 corresponding to the green filter block G, and the pixel electrode PE3 corresponding to the blue filter block B are applied with driving voltages under the control of the thin-film transistor layer 30 to attract charged white particles 26W to location near the color filter block to reflect light, so that the color of this pixel is the additive of the three primary colors of red, green, and blue to form white color. In this case, the color and brightness of this display unit (containing three pixels) are R+G+B=W.

If a display unit is planned to display black, the pixel electrode PE1 corresponding to the red filter block R, the pixel electrode PE2 corresponding to the green filter block G, and the pixel electrode PE3 corresponding to the blue filter block B are applied with driving voltages through the thin film transistor layer 30 to attract charged black particles 26B to location near the color filter block to not reflect light, so that the areas corresponding to these three color filter blocks RGB are all displayed as black (K) color.

FIGS. 2A and 2B shows another prior art color filter layer CF. As shown in FIG. 2A, this color filter layer CF is, for example, a red/green/blue (RGB) color filter layer for three primary colors, and each color filter layer containing color filter blocks in substantially rectangular shape for the three primary colors. Besides, as shown in FIG. 2B, the area of the color filter blocks only occupies ½ of the original area, while the remaining ½ area is a light-transmitting area without any color filtering effect.

With reference to FIG. 2C, this figure is a schematic diagram to show the color mixing methods for displaying red, green, and blue colors (three primary colors) based on the color filter layer CF in FIGS. 2A and 2B. With reference also to FIG. 9, if a display unit is planned to display red color, the pixel electrode PE1 corresponding to the red filter color block R is applied with a driving voltage through the control of the thin film transistor layer 30 to attract charged white particles 26W to location near the color filter block to reflect light, so that the area corresponding to the red filter color block R displays red color (½ area displays red light and the remaining ½ area is white light). Besides, the pixel electrodes PE2 and PE3 corresponding to the green filter block G and the blue filter block B are applied with driving voltages under the control of the thin-film transistor layer 30 to attract charged black particles 26B to location near the color filter block to not reflect light, rendering the areas corresponding to the green filter block G and the blue filter block B display black (K), thereby making the display unit display red color. In this case, the color and brightness of this display unit (containing three pixels) are 0.5R+0.5W+Black+Black=0.5R+0.5W.

Similarly, if a display unit is planned to display green, the pixel electrode PE2 corresponding to the green filter block G is applied with a driving voltage under the control of the thin-film transistor layer 30 to attract charged white particles 26W to location near the color filter block to reflect light, so that the area corresponding to the green filter block G display green color (½ area displays green and the remaining ½ area is white). Besides, the pixel electrodes PE1 and PE3 corresponding to the red filter block R and the blue filter block B are applied with driving voltages under the control of the thin-film transistor layer 30 to attract charged black particles 26B to location near the color filter block to not reflect light, so that the areas corresponding to the red filter block R and the blue filter block B are black (K) color, thereby making the display unit display green color. In this case, the color and brightness of this display unit (containing three pixels) are 0.5G+0.5W+Black+Black=0.5G+0.5W.

If a display unit is planned to display blue color, the corresponding pixel electrodes PE1 to PE3 can be controlled in a similar manner. In this case, the color and brightness of this display unit containing three pixels are 0.5B+0.5W+Black+Black=0.5B+0.5W. In comparison with the first prior art method, the color filter layer CF shown in FIGS. 2A and 2B can improve brightness, however, the color saturation thereof is sacrificed, resulting in a whitening effect to display color close to Morandi colors.

With reference to FIG. 2D, this figure is a schematic diagram to show the color mixing methods for displaying yellow (Y), magenta (M), and cyan (C) based on the color filter layer CF in FIGS. 2A and 2B. If a display unit is planned to display yellow color, the pixel electrode PE1 corresponding to the red filter block R and the pixel electrode PE2 corresponding to the green filter block G are applied with driving voltages through the driving circuit layer 30 to attract charged white particles 26W to location near the color filter block to reflect light. Meanwhile, the pixel electrode PE3 corresponding to the blue filter block B is applied with a driving voltage through the thin-film transistor layer 30 to attract charged black particles 26B to location near the color filter block to not reflect light, rendering the area corresponding to the blue filter block B display black (K) color. The areas corresponding to the red filter block R and the green filter block G respectively display red color (½ area displays red light and the remaining ½ area displays white light) and green color (½ area displays green light and the remaining ½ area displays white light). The resulting color, after color additive scheme, is yellow. In this case, the color and brightness of this display unit containing three pixels are 0.5R+0.5W+0.5G+0.5W+Black=0.5Y+1W.

Similarly, if a display unit is planned to display magenta color, the pixel electrode PE1 corresponding to the red filter block R and the pixel electrode PE3 corresponding to the blue filter block B are applied with driving voltages under the control of the thin-film transistor layer 30 to attract charged white particles 26W to location near the color filter block to reflect light. Meanwhile, the pixel electrode PE2 corresponding to the green filter block G is applied with a driving voltage under the control of the thin-film transistor layer 30 to attract charged black particles 26B to location near the color filter block to not reflect light. The area corresponding to the green filter block G displays black (K) color, while the areas corresponding to the red filter block R and the blue filter block B display red (half of the area is red light and the remaining half is white light) and blue color (half of the area is blue light and the remaining half is white light) respectively. The resulting color, after color additive scheme, is magenta. In this case, the color and brightness of this display unit containing three pixels are 0.5R+0.5W+0.5B+0.5W+Black=0.5M+1W.

If a display unit is planned to display cyan color, the corresponding pixel electrodes PE1 to PE3 can be controlled in a similar manner. In this case, the color and brightness of this display unit containing three pixels are 0.5B+0.5W+0.5G+0.5W+Black=0.5C+1W. Similarly, although this color filter layer CF shown in FIGS. 2A and 2B improves brightness, the color saturation is sacrificed. Furthermore, the color saturation is even worse when displaying yellow, magenta, and/or cyan color.

With reference to FIG. 2E, this figure is a schematic diagram to show the color mixing methods for displaying white (W) and black (K) based on the color filter layer CF in FIGS. 2A and 2B. If a display unit is planned to display white color, the pixel electrode PE1 corresponding to the red filter block R, the pixel electrode PE2 corresponding to the green filter block G, and the pixel electrode PE3 corresponding to the blue filter block B are applied with driving voltages under the control of the thin-film transistor layer 30 to attract charged white particles 26W to location near the color filter block to reflect light, so that the color of these pixels is the addition of the three primary colors of red, green, and blue to become white color. In this case, the color and brightness of this display unit containing three pixels are 0.5R+0.5W+0.5G+0.5W+0.5B+0.5W=(0.5R+0.5G+0.5B)+1.5W=2W.

If a display unit is planned to display black color, the pixel electrode PE1 corresponding to the red filter block R, the pixel electrode PE2 corresponding to the green filter block G, and the pixel electrode PE3 corresponding to the blue filter block B are applied with driving voltages through the thin film transistor layer 30 to attract charged black particles 26B to location near the color filter block to not reflect light, so that the area corresponding to these three color filter blocks RGB displays black (K) color.

However, there is still room for improvement in the conventional color filter layer (CF).

### SUMMARY OF THE INVENTION

The purpose of this invention is to provide a reflective color display with a color filter layer. By the specially designed color filter layer, the reflective color display can have better brightness and color saturation.

Accordingly, the present invention provides a reflective color display with a color filter layer, comprising:
a first substrate comprising a first surface and a second surface, wherein a thin-film transistor layer and a pixel electrode layer are formed on the second surface, the thin-film transistor layer comprises a plurality of thin-film transistors, a plurality of gate lines and a plurality of data lines and a plurality of storage capacitors, the plurality of gate lines are arranged along a first direction, the plurality of data lines are arranged along a second direction, the first direction and the second direction are substantially perpendicular to each other, and the pixel electrode layer comprises a plurality of pixel electrodes;
a color filter layer comprising a plurality of color filter blocks, wherein for at least half of the color filter blocks, any two adjacent color filter blocks do not overlap in the projection direction, or an overlapping area of the adjacent color filter blocks in the projection direction is less than 30% of an area of a single one of the filter color blocks; wherein part of the color filter blocks have one-to-one correspondence with the plurality of pixel electrodes, part of the color filter blocks have multiple-to-one or one-to-multiple correspondence with the plurality of pixel electrodes; and
a display material layer arranged in a direction away from the second surface of the first substrate.

### BRIEF DESCRIPTION OF THE DRAWINGS

FIG. 1A shows an embodiment of a prior art color filter layer CF.

FIG. 1B shows the color mixing methods for displaying red, green, and blue colors respectively according to the color filter layer in FIG. 1A.

FIG. 1C is a schematic diagram to show the color mixing methods for displaying yellow (Y), magenta (M), and cyan (C) based on the color filter layer in FIG. 1A.

FIG. 1D is a schematic diagram to show the color mixing methods for displaying white (W) and black (K) based on the color filter layer in FIG. 1A.

FIGS. 2A and 2B shows another prior art color filter layer.

FIG. 2C shows the color mixing methods for displaying red, green, and blue colors respectively according to the color filter layer in FIGS. 2A and 2B.

FIG. 2D is a schematic diagram to show the color mixing methods for displaying yellow (Y), magenta (M), and cyan (C) based on the color filter layer in FIGS. 2A and 2B.

FIG. 2E is a schematic diagram to show the color mixing methods for displaying white (W) and black (K) based on the color filter layer in FIGS. 2A and 2B.

FIG. 3A is a schematic diagram showing the color filter layer applicable to the reflective color display according to the present invention.

FIG. 3B is a schematic diagram showing the color filter layer applicable to the reflective color display according to another embodiment of the present invention.

FIG. 4A shows the color mixing methods for displaying red, green, and blue colors respectively according to the color filter layer in FIG. 3A.

FIG. 4B is a schematic diagram to show the color mixing methods for displaying yellow (Y), magenta (M), and cyan (C) based on the color filter layer in FIG. 3A.

FIG. 4C is a schematic diagram to show the color mixing methods for displaying white (W) and black (K) based on the color filter layer in FIG. 3A.

FIG. 5A is a schematic diagram showing a reflective color display according to the present invention.

FIG. 5B is a schematic diagram showing a reflective color display according to another embodiment of the present invention.

FIG. 5C is a schematic diagram showing a reflective color display according to another embodiment of the present invention.

FIG. 5D is a schematic diagram showing a reflective color display according to another embodiment of the present invention.

FIG. 6A is a schematic diagram showing a reflective color display according to another embodiment of the present invention.

FIG. 6B is a schematic diagram showing a reflective color display according to another embodiment of the present invention.

FIG. 7A is a schematic diagram showing a reflective color display according to another embodiment of the present invention.

FIG. 7B is a schematic diagram showing a reflective color display according to another embodiment of the present invention.

FIGS. 8A and 8B are sectional view and top view for explaining the structure and manufacturing process of the thin film transistor layer and related components on the control substrate of the present invention.

FIG. 9 shows a schematic view of the prior art color electrophoresis display.

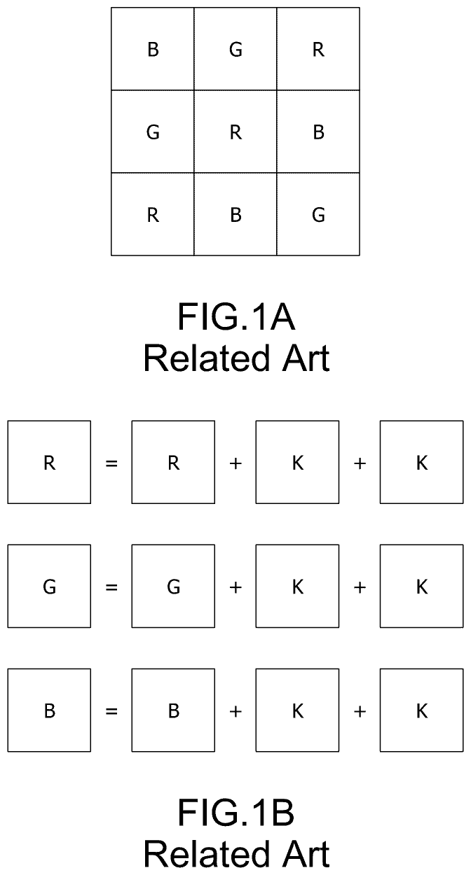

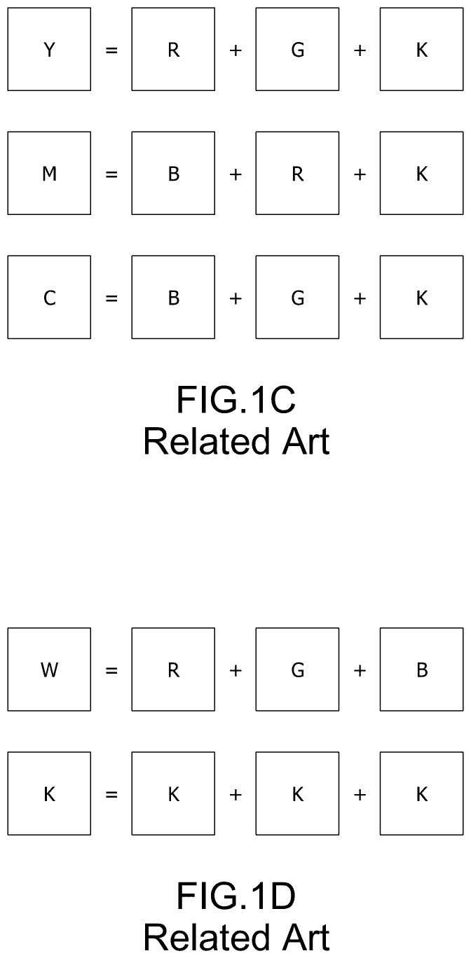

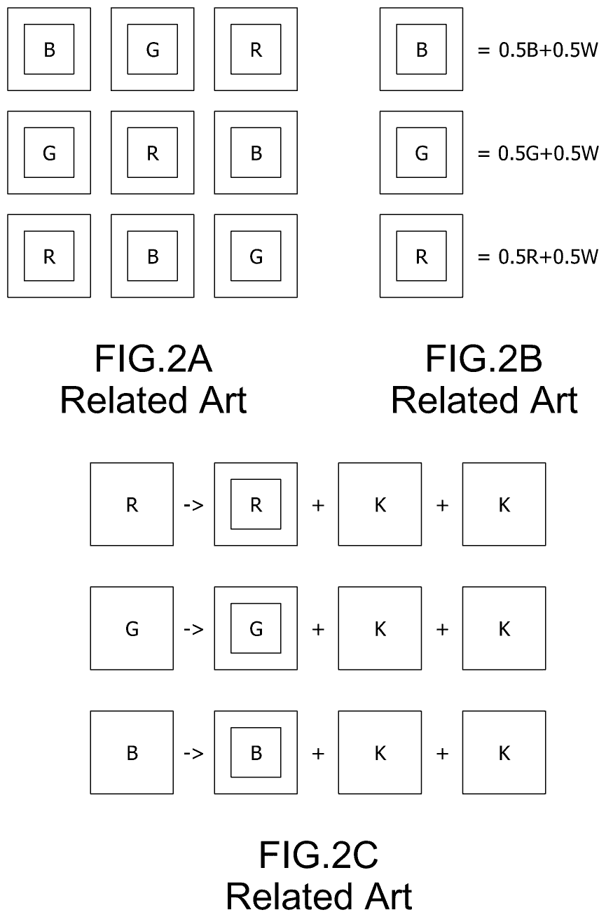

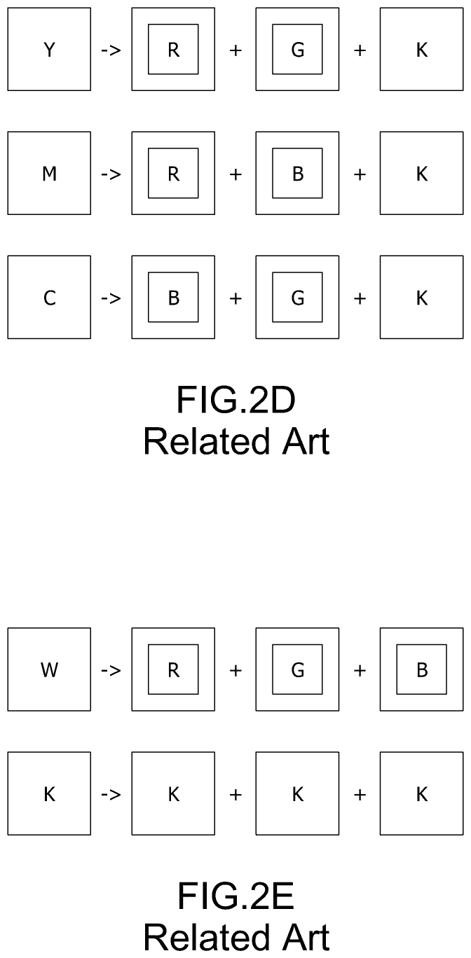

### DETAILED DESCRIPTION

It should be understood that the orientations or positional relationships in this disclosure which are indicated by the terms such as “front side”, “rear side”, “left side”, “right side”, “front end”, “rear end”, “end”, “vertical”, “horizontal”, “top” and “bottom” are based on the orientations or positional relationships as shown in the drawings. These are only used for describing this disclosure and simplifying the description rather than indicating or implying that the device or element have a specific orientation or be constructed and operated in a specific orientation, and it should not be considered as limitations of the scopes of this disclosure.

In the description below, terms such as “first,” “second,” “third,” “fourth,” and “fifth” describe various elements, components, regions, layers, and/or parts, which should not be limited by these terms. These terms are used only to distinguish one element, component, region, layers, or part from another. Unless the context clearly indicates otherwise, the use of terms such as “first,” “second,” “third,” “fourth,” and “fifth” herein does not imply order or sequence.

The terms used herein without additional definition such as “substantially” and “approximately” are used to describe and illustrate small changes. When used in an event or situation, the term may include the precise moment at which the event or situation occurs, and a close approximation to moment the event or situation occurs. For example, when combined with a numerical value, the term may include a range of variation less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

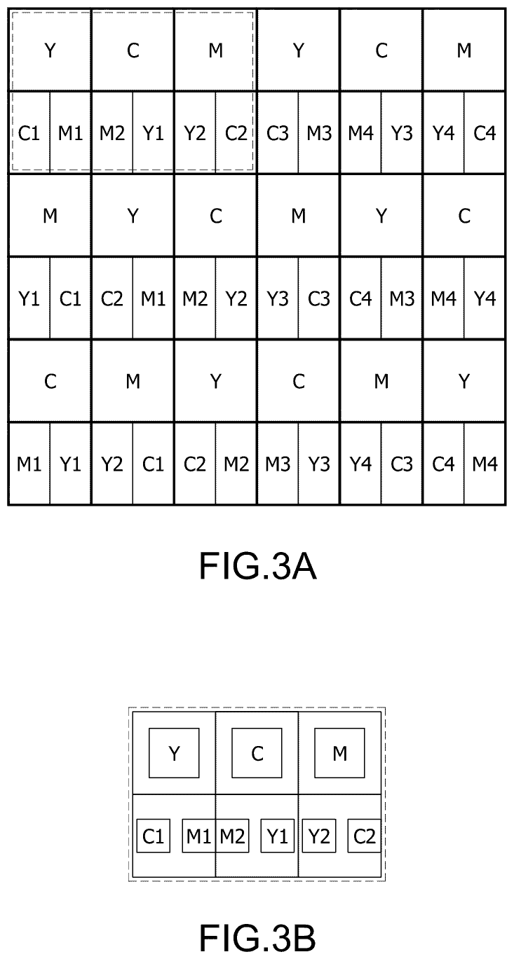

With reference to FIG. 3A, this figure is a schematic diagram showing the color filter layer CF applicable to the reflective color display 100 according to the present invention. This color filter layer CF includes multiple color filter blocks Y, Y1~Y4, C, C1~C4, M, M1~M4. According to one embodiment of the present invention, the color filter blocks are arranged on the same plane, and there is no overlap between adjacent color filter blocks in the projection direction. However, those skilled in the art will understand that due to process factors during the fabrication of the color filter blocks, some adjacent color filter blocks may have overlap therebetween. According to one embodiment of the present invention, the overlapping area of the adjacent color filter blocks in the projection direction is less than 30% of the area of a single color filter block; according to another embodiment of the present invention, the overlapping area of adjacent color filter blocks in the projection direction is less than 20% of the area of a single color filter block. According to still another embodiment of the present invention, for at least half of the color filter blocks, any two adjacent color filter blocks do not have overlap therebetween in the projection direction. Besides, according to the present invention, the color filter blocks are also arranged on different planes or on the same plane, as long as the overlapping area of the adjacent color filter blocks, even if they are not on the same plane, in the projection direction is less than 30% or 20% of the area of a single filter color block, or for at least half of the filter color blocks, any two adjacent color filter blocks do not have overlap therebetween in the projection direction. The above different embodiments are within the scope of the present invention.

Furthermore, as shown in Fig. FIG. 3A, at least six color filter blocks are combined to form a full-color filter pixel unit (as shown in the dashed box). For example, the seven color filter blocks Y, C, M and C1, (M1,M2), (Y1,Y2), C2 are combined to form a full-color filter pixel unit, so that these full-color filter pixel units extend in both the horizontal and vertical directions to form a complete color filter layer CF. When these full-color filter pixel units extend in the horizontal or vertical direction, there is an offset displacement between adjacent rows or columns in the vertical or horizontal direction. As shown in FIG. 3A, the color filter block C at the upper left corner and the color filter block C2 in the second row are arranged with an offset of one and a half pixel electrodes, where one pixel electrode is corresponding to the position of the thick frame in FIG. 3A. That is, the color filter blocks in the second row are formed by offsetting the first row of color filter blocks by one and a half pixel electrodes; the color filter blocks in the third row are formed by offsetting the second row of color filter blocks by half a pixel electrode. However, according to the present invention, the color filter blocks can be arranged or formed in different ways as needed. For example, if the positions of the color filter blocks Y2 and C2 are swapped, that is, if the filter color blocks C2+C3 are not connected, then the filter color blocks in the second row are offset from the filter color blocks in the first row by one pixel electrode. In the following description, the color filter layer CF of FIG. 3A is used for demonstration, and at least six filter color blocks are combined to form a full-color filter pixel unit (as shown in the dashed box) for illustration.

FIG. 3B is a schematic diagram showing a color filter layer applicable to the reflective color display according to another embodiment of the present invention. According to another embodiment of the present invention, each of the filter color blocks needs not have the same area as that of the corresponding pixel electrode PE. At least part of the filter color blocks may have a corresponding partial area. For example, the filter color block may have an area of 70% of the area of the corresponding pixel electrode PE, with the remaining 30% being the light-transmitting area. It should be noted that, for the sake of simplicity, FIG. 3B only illustrates the color filter block structure of the “full-color pixel filter unit” corresponding to the upper left side of FIG. 3A. However, those skilled in the art should be able to modify the other filter block structures in FIG. 3A based on the layout shown in FIG. 3B. As shown in FIG. 3B, when fabricating the color filter layer of the present invention, the same color filter block can span the regions corresponding to different pixel electrodes PE. For example, as shown in FIG. 3B, the color filter block (M1, M2) spans the regions corresponding to different pixel electrode. Furthermore, the adjacent color filter block(s) of the same color can also be separate color filter blocks. For example, the adjacent color filter blocks Y1 and Y2 shown in FIG. 3B are separate to each other. Furthermore, similar to the arrangement of the color filter layer in FIG. 3A, the color filter layer in FIG. 3B can have color filter blocks distributed on different planes. In the direction viewed along the projection direction, the adjacent color filter blocks, even not arranged on the same plane, have overlapping area therebetween with area less than 30% or 20% of the area of a single filter color block; alternatively, for at least half of the filter color blocks in FIG. 3B, any two adjacent color filter blocks do not have overlap therebetween in the projection direction. The above different embodiments are within the scope of the present invention.

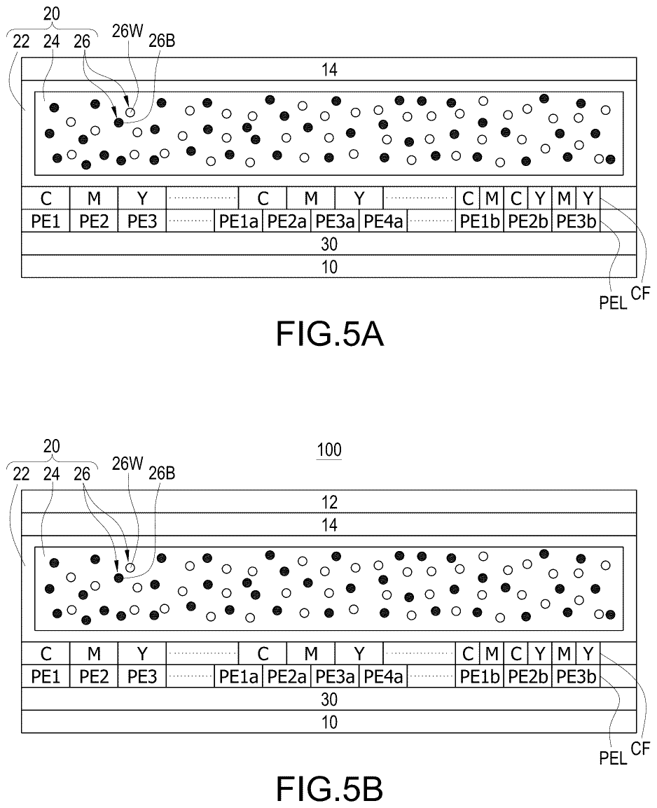

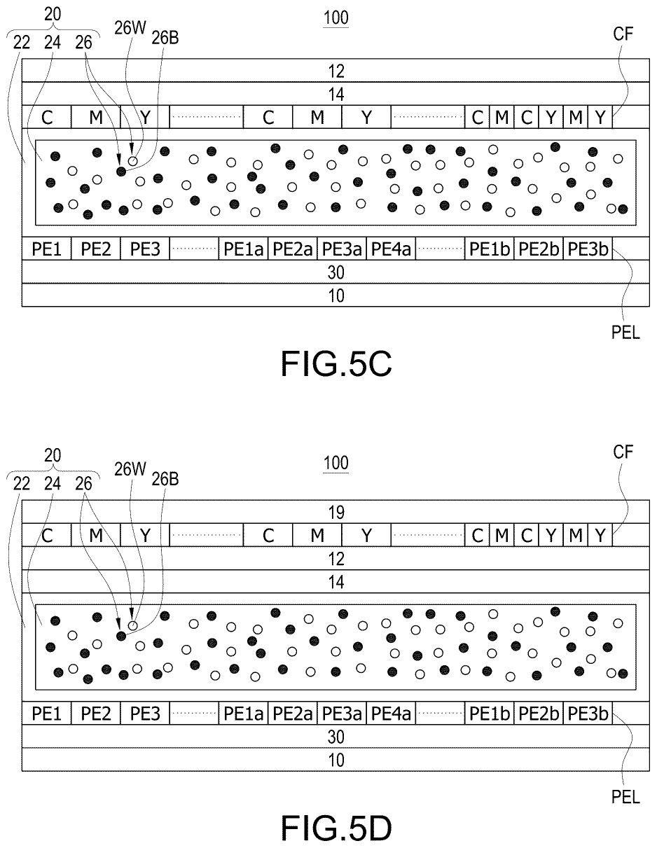

With reference to FIG. 5A, this figure is a schematic diagram showing a reflective color display 100 according to the present invention. This reflective color display 100 is, for example, an electrophoresis color display, and includes, from top to bottom, a common electrode layer 14, a display material layer 20 (for example, an electrophoresis layer), a color filter layer CF, a pixel electrode layer PEL, a thin-film transistor layer 30, and a first substrate 10. The display material layer 20 includes a plurality of hollow chambers 22 (only one is shown in the figure). For example, the hollow chamber 22 may be a cell formed by a micro-cup, a capsule, or a cavity formed by micro partition. A colloidal solution 24 is filled in each hollow chamber 22 and contains a plurality of suspended charged color particles 26 (for example, charged black particles 26B and charged white particles 26W). The hollow chamber 22 is used as a container for electronic ink (or electrophoresis material). The hollow chamber 22 is, for example, made of an organic polymer material and is used to fill charged color particles 26. The color filter layer CF includes a plurality of filter color blocks C, M, Y. The pixel electrode layer PEL includes a plurality of pixel electrodes PE1, PE2, PE3 . . . PE1a, PE2a, PE3a . . . PE1b, PE2b, PE3b. The electrophoresis color display of FIG. 5A does not require a substrate 12 as that shown in FIG. 5B, and the common electrode layer 14 can be bonded to the glue frame (not shown) of the display material layer 20 for fixation.

As shown in FIGS. 3A and 5A, according to the present invention, some color filter blocks (for example, the color filter blocks C, M, Y) have one-to-one correspondence with the pixel electrodes (for example, the pixel electrodes PE1, PE2, PE3); some of the color filter blocks (for example, the color filter blocks C1, M1) have multiple-to-one correspondence with the pixel electrodes (for example, the pixel electrode PE1b); and some of the color filter blocks (for example, the color filter block C) have one-to-multiple correspondence with the pixel electrodes (for example, the pixel electrodes PE1a and PE2a).

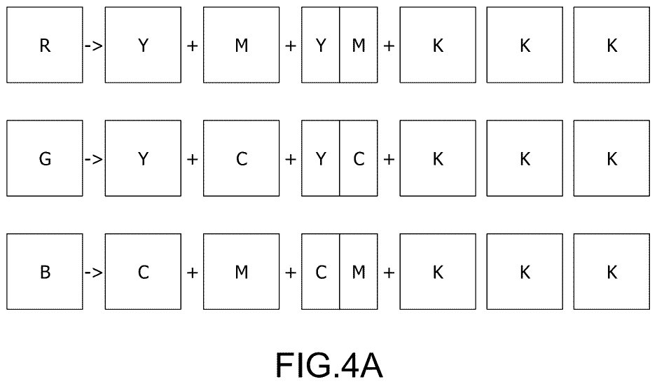

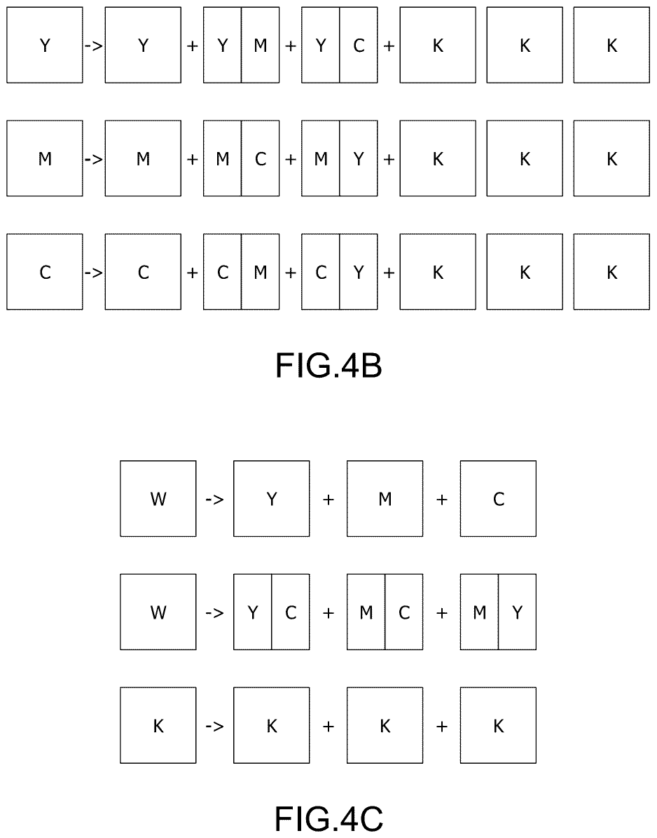

With reference to FIG. 4A, this figure shows the color mixing method for displaying red, green, and blue colors respectively based on the color filter layer CF in FIG. 3A. According to the present invention, at least six color filter blocks are combined to form a full-color filter pixel unit. If the full-color filter pixel unit is planned to display red color, the pixel electrodes corresponding to the yellow filter block Y and the magenta filter block M in FIG. 3A are applied with driving voltage to attract white particles to location near the color filter block to reflect light, while the pixel electrodes corresponding to the filter block (M2, Y1) in FIG. 3A are applied with driving voltages to attract white particles to location near the color filter block to reflect light, and the pixel electrodes corresponding to the remaining color filter blocks are applied with driving voltages to attract black particles to location near the color filter block to not reflect light, thereby mixing the yellow color and the magenta color in additive color effect to provide red color. In this case, the total brightness is Y+M+0.5Y+0.5M==1.5R+(1.5G+1.5R+1.5B)=1.5R+1.5W.

If the full-color pixel filter unit is scheduled to display green color, the pixel electrodes corresponding to the yellow filter block Y and the cyan filter block C in FIG. 3A are applied with driving voltages to attract white particles to location near the color filter block to reflect light, while the pixel electrodes corresponding to the color filter block (Y2, C2) in FIG. 3A is applied with driving voltage to attract white particles to location near the color filter block to reflect light, and the pixel electrodes corresponding to the remaining color filter blocks are applied with suitable driving voltages to attract black particles to location near the color filter block to not reflect light. Therefore, green color is displayed by the additive color mixing of yellow color and cyan color. In this case, the total brightness is Y+C+0.5Y+0.5C=1.5Y+1.5C=1.5G+(1.5R+1.5G+1.5B)=1.5G+1.5W.

If the full-color pixel filter unit is scheduled to display blue color, the pixel electrodes corresponding to the magenta filter block M and the cyan filter block C in FIG. 3A are applied with driving voltages to attract white particles to location near the color filter block to reflect light, while the pixel electrodes corresponding to the color filter block (C1, M1) in FIG. 3A is applied with driving voltage to attract white particles to location near the color filter block to reflect light, and the pixel electrodes corresponding to the remaining color filter blocks are applied with suitable driving voltages to attract black particles to location near the color filter block to not reflect light. Therefore, blue color is displayed by the additive color mixing of magenta color and cyan color. In this case, the total brightness is C+M+0.5C+0.5M=1.5C+1.5M=1.5B+(1.5G+1.5R+1.5B)=1.5B+1.5W.

With reference to FIG. 4B, this figure shows the color mixing method for displaying yellow (Y), magenta (M), and cyan (C) respectively based on the color filter layer CF in FIG. 3A. If this full-color filter pixel unit is scheduled to display yellow color, the pixel electrode corresponding to the yellow filter block Y in FIG. 3A is applied with suitable driving voltage to attract white particles to location near the color filter block to reflect light, the pixel electrode corresponding to the filter (M2, Y1) in FIG. 3A is applied with suitable driving voltage to attract white particles to location near the color filter block to reflect light, the pixel electrode corresponding to the color filter block (Y2, C2) in FIG. 3A is applied with suitable driving voltage to attract white particles, and the pixel electrode corresponding to the remaining color filter blocks are applied with suitable driving voltages to attract black particles to location near the color filter block to not reflect light. Therefore, yellow color is displayed by the additive color mixing of magenta color and cyan color. In this case, the total brightness is Y+0.5Y+0.5M+0.5Y+0.5C=1.5Y+(0.5Y+0.5M+0.5C)=1.5Y+W.

If this full-color filter pixel unit is scheduled to display a magenta color, then the pixel electrode corresponding to the magenta filter block M in FIG. 3A is applied with suitable driving voltage to attract white particles to location near the color filter block to reflect light, the pixel electrode corresponding to the color filter block (C1, M1) in FIG. 3A is applied with suitable driving voltage to attract white particles to location near the color filter block to reflect light, the pixel electrode corresponding to the color filter block (Y1, M1) in FIG. 3A is applied with suitable driving voltage to attract white particles to location near the color filter block to reflect light, and the pixel electrode corresponding to the remaining color filter blocks are applied with suitable driving voltages to attract black particles to location near the color filter block to not reflect light. Therefore, magenta color is displayed by the additive color mixing of yellow color and cyan color. In this case, the total brightness is M+0.5M+0.5C+0.5M+0.5Y=1.5M+(0.5M+0.5C+0.5Y)=1.5M+W.

If this full-color filter pixel unit is scheduled to display cyan color, then the pixel electrode corresponding to the cyan filter block C in FIG. 3A is applied with suitable driving voltage to attract white particles to location near the color filter block to reflect light, the pixel electrode corresponding to the color filter block (C1, M1) in FIG. 3A is applied with suitable driving voltage to attract white particles to location near the color filter block to reflect light, the pixel electrode corresponding to the color filter block (Y2, C2) in FIG. 3A is applied with suitable driving voltage to attract white particles to location near the color filter block to reflect light, and the pixel electrode corresponding to the remaining color filter blocks are applied with suitable driving voltages to attract black particles to location near the color filter block to not reflect light. Therefore, cyan color is displayed by the additive color mixing of yellow color and magenta color. In this case, the total brightness is C+0.5C+0.5M+0.5C+0.5Y=1.5C+(0.5M+0.5C+0.5Y)=1.5C+W.

With reference to FIG. 4C, this figure shows the color mixing method for displaying white (W) and black (B) respectively based on the color filter layer CF in FIG. 3A. If this full-color filter pixel unit is scheduled to display white color, then the pixel electrodes corresponding to all the color filter blocks in this full-color filter pixel unit, namely yellow filter block Y, cyan filter block C, magenta filter block M, color filter block (C1, M1), color filter block (M2, Y1), and color filter block (Y2, C2) are applied with suitable driving voltages through the control of the thin-film transistor layer 30 to attract charged white particles 26W to location near the color filter block to reflect light. The color of this pixel is made by adding yellow, cyan, and magenta to create white color. In this case, part of the brightness is Y+M+C=R+G+R+B+G+B=2R+2G+2B=2W, and the other part of the brightness is 0.5Y+0.5C+0.5M+0.5C+0.5M+0.5Y=2R+2G+2B=2W, for a total brightness of 4W.

If this full-color filter pixel unit is scheduled to display black color, then the pixel electrodes corresponding to all the color filter blocks in this full-color filter pixel unit, namely yellow filter block Y, cyan filter block C, magenta filter block M, color filter block (C1, M1), color filter block (M2, Y1), and color filter block (Y2, C2) are applied with suitable driving voltages through the control of the thin-film transistor layer 30 to attract charged black particles 26B to location near the color filter block to not reflect light, so that the area corresponding to all of the color filter blocks display black (K) color.

Below is a comparison table of the color filter layer CF of the present invention and the prior art color filter layer. Furthermore, because the present invention drives six pixel electrodes for a single full-color filter pixel unit, while the prior art drives three pixel electrodes, the results obtained by the present invention are obtained by multiplying the results of FIG. 4A-4C above by 50% and compare them with the prior art. As can be seen from the table below, the color filter layer CF of the present invention can balance brightness and color saturation. In addition, when a color display using the color filter layer CF of FIG. 3A displays white in full screen, its display brightness is not less than 50% of the brightness of a full white screen. The aforementioned brightness of a full-white screen is defined as the white light intensity of reflected light in the area without a color filter layer. In other word, the white light intensity of the reflected light for an area related to a single pixel electrode not blocked by the color filter layer is W. Therefore, the white light intensity of the reflected light for three pixels not blocked by the color filter layer is 3W. According to the table below, the brightness of the color display according to this invention when displaying white in full screen is 2W (after multiplying by 50%), therefore its display brightness is not less than fifty percent of the brightness of a full-white screen.

| | The present invention | Prior Art 1 | Prior Art 2 |
|---|---|---|---|
| Red | 0.75R + 0.75W | R | 0.5R + 0.5W |
| Blue | 0.75B + 0.75W | B | 0.5B + 0.5W |
| Green | 0.75G + 0.75W | G | 0.5G + 0.5W |
| Cyan | 0.75C + 0.5W | B + G | 0.5C + W |
| Magenta | 0.75M + 0.5W | B + R | 0.5M + W |
| Yellow | 0.75Y + 0.5W | R + G | 0.5Y + W |
| White | 2W | W | 2W |

FIG. 5B is a schematic diagram showing a reflective color display 100 according to another embodiment of the present invention. This reflective color display 100 is, for example, an electrophoresis color display, and is similar to the embodiment of FIG. 5A. However, the reflective color display 100 of the embodiment of FIG. 5B further includes an opposite substrate 12. When manufacturing this reflective color display 100, a thin film transistor layer 30, a pixel electrode layer PEL, a color filter layer CF, and a display material layer 20 can be fabricated on the control substrate 10, and then the resulted structure combined with the opposite substrate 12 on which a common electrode layer 14 is fabricated to construct a complete electrophoresis color display 100.

FIG. 5C is a schematic diagram showing a reflective color display 100 according to another embodiment of the present invention. This reflective color display 100 is, for example, an electrophoresis color display, and is similar to the embodiment in FIG. 5B. However, in the embodiment of FIG. 5C, the color filter layer CF of the reflective color display 100 is moved from a position close to the control substrate 10 to a position close to the opposite substrate 12. Namely, the color filter layer CF of the reflective color display 100 is moved to a place between the display material layer 20 and the common electrode layer 14. When manufacturing this reflective color display 100 in FIG. 5C, a thin film transistor layer 30, a pixel electrode layer PEL, and a display material layer 20 are fabricated on the control substrate 10, and then combined with the opposite substrate 12 on which a common electrode layer 14 and a color filter layer CF are fabricated to construct a complete electrophoresis color display 100.

FIG. 5D is a schematic diagram of a reflective color display 100 according to another embodiment of the present invention. This reflective color display 100 is, for example, an electrophoresis color display, and is similar to the embodiment in FIG. 5C. But in in embodiment of FIG. 5D, the color filter layer CF is moved to a position further away from the control substrate 10, that is, on the side of the opposite substrate away from the control substrate 10. The color filter layer CF is arranged on a filter substrate 19 and is located between the opposite substrate 12 and the filter substrate 19. When manufacturing this reflective color display 100, a thin film transistor layer 30, a pixel electrode layer PEL, and a display material layer 20 are fabricated on the control substrate 10. Afterward, the resulting structure is combined with the opposite substrate 12 on which a common electrode layer 14 is fabricated, and then a filter substrate 19 on which a color filter layer CF is fabricated can be bonded to the resulting structure to construct a complete electrophoresis color display 100.

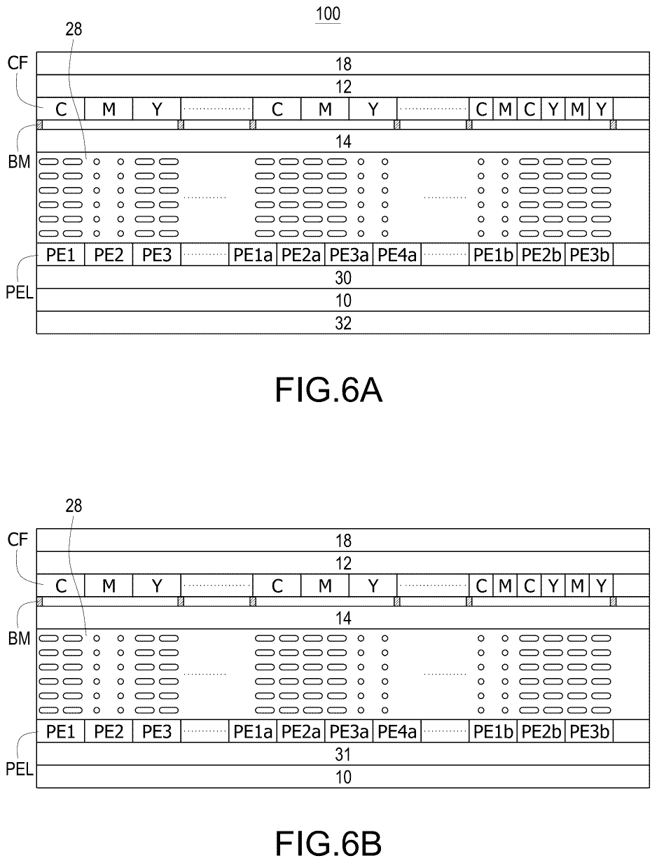

FIG. 6A is a schematic diagram showing a reflective color display 100 according to another embodiment of the present invention. This reflective color display 100 is, for example, a reflective color liquid crystal display, and includes, from top to bottom, a polarizing layer 18, an opposite substrate 12, a color filter layer CF, a black matrix layer BM, a common electrode layer 14, a display material layer 28 filled with liquid crystal material, a pixel electrode layer PEL, a thin film transistor layer 30, a control substrate 10, and a light-reflective layer 32.

FIG. 6B is a schematic diagram showing a reflective color display 100 according to another embodiment of the present invention. This reflective color display 100 is, for example, a reflective color liquid crystal display, and includes, from top to bottom, a polarizing layer 18, an opposite substrate 12, a color filter layer CF, a black matrix layer BM, a common electrode layer 14, a display material layer 28 filled with liquid crystal material, a pixel electrode layer PEL, a thin-film transistor layer 31 with a light-reflective layer, and a control substrate 10. This embodiment differs from the embodiment in FIG. 6A in that the light-reflective layer in FIG. 6B is arranged within the thin-film transistor layer, such that the pixel electrode layer (not shown) within the thin-film transistor layer is employed as the light-reflective layer.

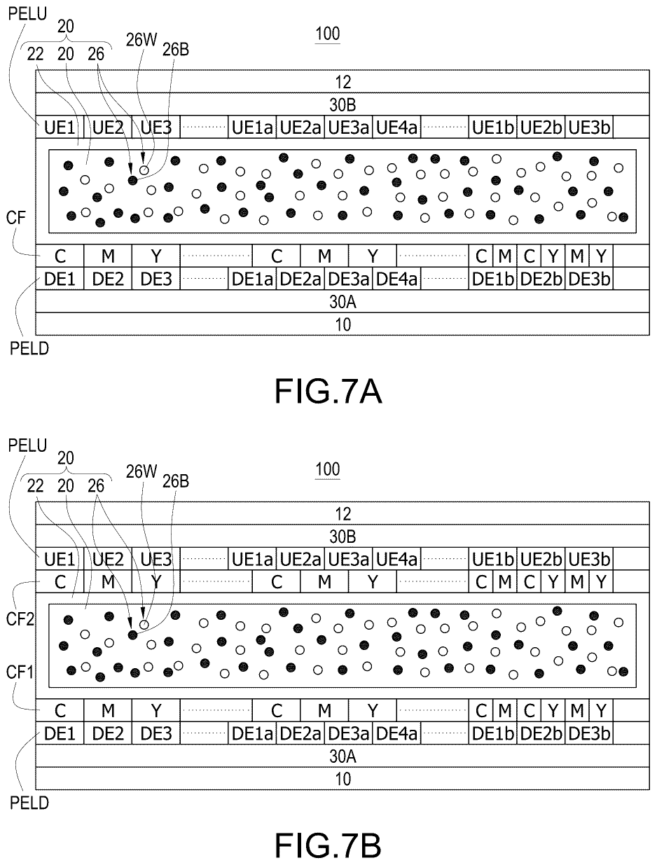

FIG. 7A is a schematic diagram of a reflective color display 100 according to another embodiment of the present invention. This reflective color display 100 is, for example, an electrophoresis color display, and has double-sided display (one side is black and white, while the other side is color). This reflective color display 100 includes, from top to bottom, an opposite substrate (second substrate) 12, an opposite thin-film transistor layer (second thin-film transistor layer) 30B, an opposite pixel electrode layer (second pixel electrode layer) PELU, a display material layer 20 (for example, an electrophoresis layer), a color filter layer CF, a pixel electrode layer (first pixel electrode layer) PELD, a thin-film transistor layer (first thin-film transistor layer) 30A, and a control substrate (first substrate) 10. As shown in the figure, the opposite thin-film transistor layer (second thin-film transistor layer) 30B and the opposite pixel electrode layer (second pixel electrode layer) PELU are arranged on one surface of the opposite substrate (second substrate) 12. The opposite thin-film transistor layer (second thin-film transistor layer) 30B includes multiple thin-film transistors, multiple gate lines, and multiple data lines (the details thereof will be described later). The opposite pixel electrode layer (second pixel electrode layer) PELU includes multiple pixel electrodes UE1, UE2, UE3, UE1a, UE2a, UE3a, UE4a, UElb, UE2b, and UE3b. The thin-film transistor layer (first thin-film transistor layer) 30A and the pixel electrode layer (first pixel electrode layer) PELD are arranged on one surface of the control substrate (first substrate) 10. The thin-film transistor layer (first thin-film transistor layer) 30A includes multiple thin-film transistors, multiple gate lines and multiple data lines (the details thereof will be described later), and the pixel electrode layer (first pixel electrode layer) PELD includes multiple pixel electrodes DE1, DE2, DE3, DE1a, DE2a, DE3a, DE4a, DElb, DE2b, DE3b.

FIG. 7B is a schematic diagram of a reflective color display 100 according to another embodiment of the present invention. This reflective color display 100 is, for example, an electrophoresis color display, and specifically an electrophoretic color display capable of double-sided display (both sides are color). The structure of this reflective color display 100 is generally similar to the embodiment in FIG. 7A, but an additional color filter layer (second color filter layer) CF2 is provided between the display material layer 20 and the opposite pixel electrode layer (second pixel electrode layer) PELU to achieve a double-sided color display. In this case, the original color filter layer CF is replaced by the first color filter layer CF1.

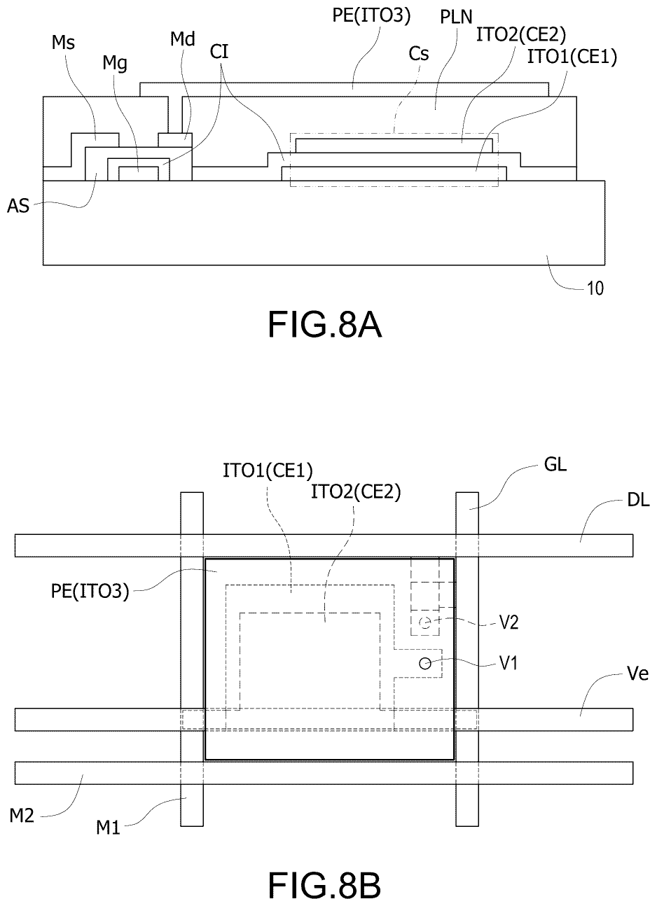

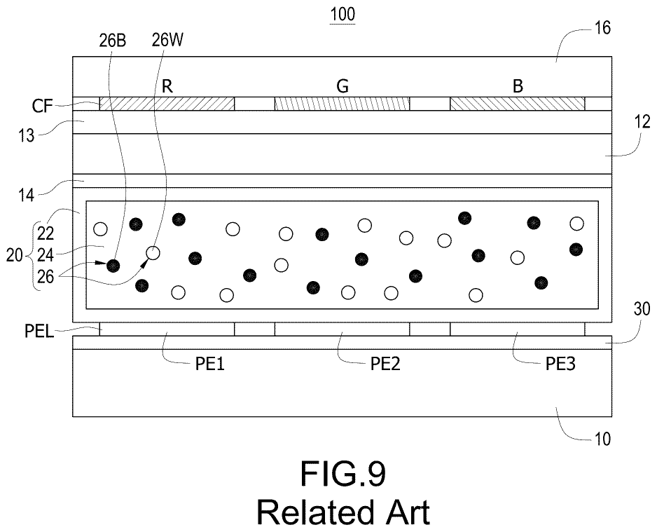

For the reflective color displays 100 in the above embodiments, please refer to FIGS. 8A and 8B, the structure and manufacturing process of the thin film transistor layer 30 and related components on the control substrate 10 of the present invention are explained.

According to the present invention, when fabricating an electrophoresis display 100 (for example, the electrophoresis display shown in FIG. 5B), for the control substrate 10 side, a metal thin film is first formed on the upper surface of the control substrate 10 using a deposition process or a sputtering process and then a first metal layer M1 is formed using a lithography process. This first metal layer M1 is used to form the gate metal Mg and the gate line GL. Afterward, a transparent conductive material thin film is formed using a sputtering process, and a first transparent conductive layer ITO1 is formed using a lithography process. The above two steps can also be interchanged, that is, the first transparent conductive layer ITO1 is formed first, and then the first metal layer M1 is formed. Afterward, a capacitor insulating layer CI (for example, using the material of SiNx or SiO2) for the storage capacitor Cs and an a-Si layer AS are deposited, and the semiconductor portion of the thin-film transistor in the thin-film transistor layer 30 is defined using a photolithography process. Afterward, a metal thin film is fabricated on the resulting structure using a deposition or sputtering process, and a second metal layer M2 is fabricated using a photolithography process. This second metal layer M2 is used to form the source metal Ms, the drain metal Md, and the data line DL. Afterward, a transparent conductive material thin film is fabricated using a sputtering process, and a second transparent conductive layer ITO2, which is served as the second storage capacitor CE2, is fabricated using a photolithography process. The two steps described above can also be interchanged. Namely, the second transparent conductive layer ITO2 is formed first, and the second metal layer M2 is then formed. Then, a planarization layer PLN is fabricated on the resulting structure using a coating and lithography process. Afterward, a transparent conductive material film is fabricated using a sputtering process, and the pixel electrode PE (for example, the third transparent conductive layer ITO3) of the pixel electrode layer PEL is fabricated using a lithography process. A display material layer 20 containing a hollow cavity 22 is then laminated or fabricated on the pixel electrode layer PEL. For example, a resin film is formed on a polymer substrate, and indentations are pressed into the resin film using a roller to create a hollow micro-cup structure 22 and then the resin film is cured. The hollow micro-cup 22 structure serves as a container for electronic ink. A colloidal solution 24 containing charged color particles 26 is then filled into the hollow micro-cup 22 structure, and the hollow micro-cup 22 is subsequently sealed and hardened with adhesive to form a sealed cavity, which becomes the display material layer 20 (for example, the electrophoresis layer). For detailed fabrication process, please refer to Taiwan Patent Application No. 93100767. Afterward, the opposite substrate 12 is fabricated. A common electrode layer 14 is formed on the opposite substrate 12, or the common electrode layer 14 can be omitted or formed on other location. Finally, the side of the control substrate 10 with the display material layer 20 is bonded to the opposite substrate 12 with optical adhesive.

With reference to FIG. 8B, the topmost pixel electrode PE is made of a transparent conductive material, such as indium tin oxide (ITO) or a similar transparent conductive material, and is electrically connected to the first transparent conductive layer ITO1 (first storage electrode CE1) of the storage capacitor Cs through the via V1; furthermore, the pixel electrode PE is also electrically connected to the drain metal Md through the via V2. Furthermore, although not fully illustrated in FIGS. 8A and 8B, in each embodiment of the present invention, the thin-film transistor layer 30 (including thin-film transistor layers 30A and 30B) comprises a plurality of thin-film transistors, a plurality of gate lines GL, and a plurality of data lines DL. The plurality of gate lines GL are arranged along a first direction, and the plurality of data lines DL are arranged along a second direction, the first direction and the second direction are substantially perpendicular to each other. The pixel electrode layer PEL comprises a plurality of pixel electrodes PE.

Furthermore, in the above embodiments, each of the plurality of color filter blocks is a non-primary color light filter block, such as cyan (C), magenta (M), and yellow (Y) filter blocks. According to one embodiment of the present invention, one, or two or all of the color filter blocks has a full width at half maximum (FWHM) of more than 150 nm in the permissible spectrum within the visible light range of 380 nm to 780 nm.

It shall be understood that the present invention may have other types of embodiments, and a person with ordinary skills in the art of the technical field of the present invention may make various changes and modifications corresponding to the present invention without deviating the principle and substance of the present invention; however, such corresponding changes and modification shall be considered to be within the claimed scope of the present invention.

What is claimed is:

1. A reflective color display with color filter layer, the reflective color display comprising:
a first substrate comprising a first surface and a second surface, wherein a thin-film transistor layer and a pixel electrode layer are formed on the second surface, the thin-film transistor layer comprises a plurality of thin-film transistors, a plurality of gate lines and a plurality of data lines and a plurality of storage capacitors, the plurality of gate lines are arranged along a first direction, the plurality of data lines are arranged along a second direction, the first direction and the second direction are substantially perpendicular to each other, and the pixel electrode layer comprises a plurality of pixel electrodes;
a color filter layer comprising a plurality of color filter blocks, wherein for at least half of the color filter blocks, any two adjacent color filter blocks do not overlap in the projection direction, or an overlapping area of the adjacent color filter blocks in the projection direction is less than 30% of an area of a single one of the filter color blocks; wherein part of the color filter blocks have one-to-one correspondence with the plurality of pixel electrodes, part of the color filter blocks have multiple-to-one or one-to-multiple correspondence with the plurality of pixel electrodes; and
a display material layer arranged in a direction away from the second surface of the first substrate.

2. The reflective color display with color filter layer in claim 1, wherein the color filter layer is arranged between the first substrate and the display material layer.

3. The reflective color display with color filter layer in claim 2, wherein the pixel electrode is made of transparent conductive material.

4. The reflective color display with color filter layer in claim 1, wherein the display material layer is filled with a colloidal solution containing charged color particles of at least one color.

5. The reflective color display with color filter layer in claim 1, wherein the display material layer is filled with liquid crystal material.

6. The reflective color display with color filter layer in claim 5, further comprising a light-reflective layer.

7. The reflective color display with color filter layer in claim 1, further comprising a second substrate, wherein the display material layer is sandwiched between the first substrate and the second substrate, a second thin-film transistor layer and a second pixel electrode layer are arranged on a third surface of the second substrate, the second thin-film transistor layer comprises a plurality of thin-film transistors, a plurality of gate lines and a plurality of data lines, and the second pixel electrode layer comprises a plurality of pixel electrodes.

8. The reflective color display with color filter layer in claim 7, further comprising a second color filter layer containing a plurality of color filter blocks, wherein part of the filter color blocks in the second color filter layer are in one-to-one correspondence with the plurality of pixel electrodes of the second pixel electrode layer, and part of the color filter blocks in the second color filter layer are in multiple-to-one or one-to-multiple correspondence with the plurality of pixel electrodes of the second pixel electrode layer.

9. The reflective color display with color filter layer in claim 7, wherein the color filter layer is arranged between the second substrate and the display material layer.

10. The reflective color display with color filter layer in claim 9, further comprising a common electrode layer arranged between the second substrate and the display material layer.

11. The reflective color display with color filter layer in claim 1, wherein at least six filter blocks are combined into a full-color color filter pixel unit.

12. The reflective color display with color filter layer in claim 1, wherein the plurality of color filter blocks are non-primary color filter blocks.

13. The reflective color display with color filter layer in claim 12, wherein one of the color filter blocks has a full width at half maximum (FWHM) of more than 150 nm in a permissible spectrum within a visible light range of 380 nm to 780 nm.

14. The reflective color display with color filter layer in claim 11, wherein each full-color filter pixel unit comprises a magenta filter block, a yellow filter block, and a cyan filter block having one-to-one correspondence with the pixel electrode, and comprises another magenta filter block, another yellow filter block, and another cyan filter block having one-to-two correspondence with the pixel electrode.

15. The reflective color display with color filter layer in claim 11, wherein each full-color filter pixel unit comprises a magenta filter block, a yellow filter block, and a cyan filter block having one-to-one correspondence with the pixel electrode, and comprises another magenta filter block, another yellow filter block, and another cyan filter block having two-to-one correspondence with the pixel electrode.

16. The reflective color display with color filter layer in claim 1, wherein when the color display displays white color, a display brightness thereof is not less than 50% of a brightness of a full white screen.

17. The reflective color display with a color filter layer in claim 11, wherein the full-color filter pixel units are arranged in a horizontal direction and a vertical direction to form a complete color filter layer.

18. The reflective color display with color filter layer in claim 11, wherein the full-color filter pixel units are arranged in a horizontal direction or a vertical direction and there is a differential displacement between adjacent rows or columns in the vertical direction or the horizontal direction.

19. The reflective color display with color filter layer in claim 18, wherein the differential displacement is greater than or equal to one differential unit.

20. The reflective color display with color filter layer in claim 19, wherein the differential unit is area of one pixel electrode.

21. The reflective color display with color filter layer in claim 19, wherein the differential unit is half area of one pixel electrode.
